(19) United States
(12) Patent Application Publication
(10) Pub. No.: US 2012/0310484 A1
(43) Pub. Date: Dec. 6, 2012

(54) COLLISION DETECTING DEVICE FOR VEHICLE AND OCCUPANT PROTECTION SYSTEM HAVING THE SAME

(75) Inventor: Hiroshi Higuchi, Kariya-city (JP)

(73) Assignee: DENSO CORPORATION, Kariya-city (JP)

(21) Appl. No.: 13/483,563

(22) Filed: May 30, 2012

(30) Foreign Application Priority Data
May 31, 2011 (JP) 2011-121562

(51) Int. Cl. G06F 7/00; B60R 21/0132

(52) U.S. Cl. 701/46; 701/1

(57) ABSTRACT

A collision detecting device includes a first sensor, a second sensor, and a determination unit. The first sensor is disposed in a rear region of a passenger compartment of a vehicle defined from a first seat row towards a rear of the vehicle. The second sensor is disposed one of in a front region of the passenger compartment defined from the first seat row towards a front of the vehicle and at a side of the first seat row. The determination unit stores a safing threshold and a main threshold greater than the safing threshold, and determines that a side collision has occurred only when an output value of the second sensor is greater than the safing threshold and an output value of the first sensor is greater than the main threshold.

### CROSS REFERENCE TO RELATED APPLICATION

This application is based on Japanese Patent Application No. 2011-121562 filed on May 31, 2011, the disclosure of which is incorporated herein by reference.

### TECHNICAL FIELD

The present disclosure relates to a collision detecting device for a vehicle and an occupant protection system having the same.

### BACKGROUND

An occupant protection system that detects a collision to the side of a vehicle and activates an occupant protection device, such as an airbag, has been developed. For example, JP2008-74127A, which corresponds to US2008/0067794A1, describes an activation controller for activating an occupant protection device.

With regard to detection of a collision to the side of a vehicle (i.e., side collision), for example, a front area and a rear area of the side of the vehicle are detected through separate sensing systems using multiple sensors.

For example, a side collision to the front area is detected using an acceleration sensor disposed at a side of a first seat row as a main sensor and an acceleration sensor disposed at a front region of a passenger compartment (e.g., inside of an instrument panel) as a safing sensor. Also, a side collision to the rear area is detected using an acceleration sensor disposed at a side of a second seat row as a main sensor and an acceleration sensor disposed at a rear region of the passenger compartment (e.g., under a floor underneath the second seat row) as a safing sensor. In a case where the vehicle has a third seat row, the side collision to the rear area is also detected using an acceleration sensor disposed at a side of the third seat row. Here, the front area of the side of the vehicle is a side area of the vehicle including the first seat row and towards the front of the vehicle, and the rear area of the side of the vehicle is a side area of the vehicle from the first seat row toward the rear of the vehicle.

In such collision detection, a large number of sensors are necessary. Therefore, it is difficult to reduce manufacturing costs.

### SUMMARY

It is an object of the present disclosure to provide a collision detecting device for detecting a side collision of a vehicle and an occupant protection system, which are capable of reducing manufacturing costs without degrading collision detection accuracy.

According to an aspect, a collision detecting device includes a first sensor, a second sensor and a determination unit. The first sensor is disposed in a rear region of a passenger compartment of the vehicle defined from a first seat row towards the rear of the vehicle. The first sensor detects a motion of the vehicle with regard to a collision. The second sensor is disposed in one of a front region of the passenger compartment of the vehicle defined from the first seat row towards the front of the vehicle and a side area of the first seat row. The second sensor detects a motion of the vehicle with regard to a collision. The determination unit determines a side collision based on output signals from the first sensor and the second sensor. The determination unit stores a safing threshold and a main threshold that is a value greater than a value of the safing threshold. The determination unit determines that a side collision has occurred only when an output value of the second sensor is greater than the safing threshold and an output value of the first sensor is greater than the main threshold.

In such a configuration, the first sensor disposed in the rear region serves as a main sensor, and the second sensor disposed in the front region or in the side area of the first seat row serves as a safing sensor. The number of sensors for detecting a side collision can be reduced, and thus manufacturing costs can be reduced. In addition, the first sensor is used as the main sensor and redundancy is ensured due to the second sensor. Therefore, it is less likely that collision detection accuracy will be degraded, even if the number of the sensors is reduced.

The main threshold is set to a value greater than a value of the safing threshold so that the output values are more difficult to exceed the main threshold than the safing threshold under the same condition even if the units of the main threshold and the safing threshold are different. In other words, the main threshold is set to a more severe value than the value of the safing threshold.

For example, in a case where the collision detecting device is employed to an occupant protection system with an occupant protection device, the occupant protection device is activated based on a determination result of the collision detecting device to protect an occupant from an impact of a collision.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a diagram illustrating arrangement positions of a collision detecting device and an occupant protection system in a vehicle according to an embodiment;

FIG. 2 is a diagram illustrating a schematic structure of the collision detecting device and the occupant protection system according to the embodiment;

FIG. 3 is a diagram illustrating a flow of collision determination performed by the collision detecting device according to the embodiment; and

FIG. 4 is a diagram illustrating a schematic structure of a collision detecting device and an occupant protection system according to a modification of the embodiment.

### DETAILED DESCRIPTION

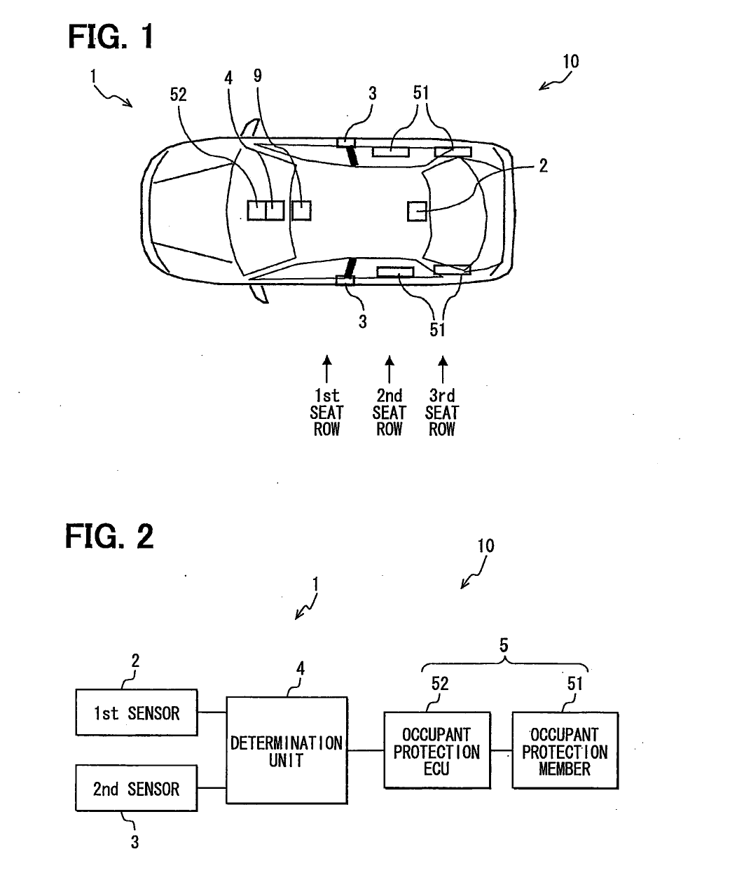

Exemplary embodiments of the present disclosure will be hereinafter described with reference to FIGS. 1 through 4.

As shown in FIGS. 1 and 2, a collision detecting device 1 according to an exemplary embodiment includes a first sensor 2, second sensors 3, and a determination unit 4.

The first sensor 2 is an acceleration sensor and is disposed in a rear region of a passenger compartment that is defined from a rear end of a first seat row toward the rear of the vehicle. For example, the first sensor 2 is disposed under a floor of a second seat row. The first sensor 2 detects a motion of the vehicle with regard to a side collision, such as a collision to a rear area of the side of the vehicle. For example, the first sensor 2 detects an acceleration, such as a change in acceleration, at a time of a side collision.

The passenger compartment means a space where an occupant(s) can stay, and is defined inside of a body of the vehicle, such as inside of panels defining outer surfaces of the vehicle and inside of outer door panel. The rear end of the first seat row substantially corresponds to a rear end of the first seat row or a rear end of a seatbelt of the first seat row, whichever disposed more to the rear of the vehicle with respect to a longitudinal direction of the vehicle. For example, the front area of the side of the vehicle is a side area of the vehicle including the first seat row and towards the front of the vehicle, and the rear area of the side of the vehicle is a side area of the vehicle from the first seat row toward the rear of the vehicle.

The second sensors 3 are acceleration sensors and are disposed at side areas of the first seat row. For example, a right second sensor 3 is disposed in the inside of a right inner panel located adjacent to an installation position of a right seatbelt of the first seat row. Likewise, a left second sensor 3 is disposed in the inside of a left inner panel located adjacent to an installation position of a left seatbelt of the first seat row.

Each of the second sensors 3 detects a motion of the vehicle with regard to a side collision, such as a collision to a rear area of the side of the vehicle. For example, the second sensor 3 detects an acceleration, such as a change in acceleration, at a time of a side collision. The second sensors 3 are also used as main sensors to detect a side collision to a front area of the side of the vehicle.

The determination unit 4 is provided by an electronic control unit (ECU). The determination unit 4 determines whether a side collision, such as a collision to the rear area of the side of the vehicle, has occurred or not based on output signals from the first sensor 2 and the second sensors 3. The determination unit 4 is, for example, disposed in the inside of the instrument panel.

The determination unit 4 has a storage member such as a read-only memory (ROM) that stores a main threshold THm and a safing threshold THs. The main threshold THm is set to a value greater than a value of the safing threshold THs so that sensor output values are more difficult to exceed the main threshold THm than the safing threshold THs. In a case where the first sensor 2 and the second sensors 3 are acceleration sensors, for example, the value of the main threshold THm is at least 20 G and at most 30 G, and the value of the safing threshold THs is at least 2 G and at most 3 G.

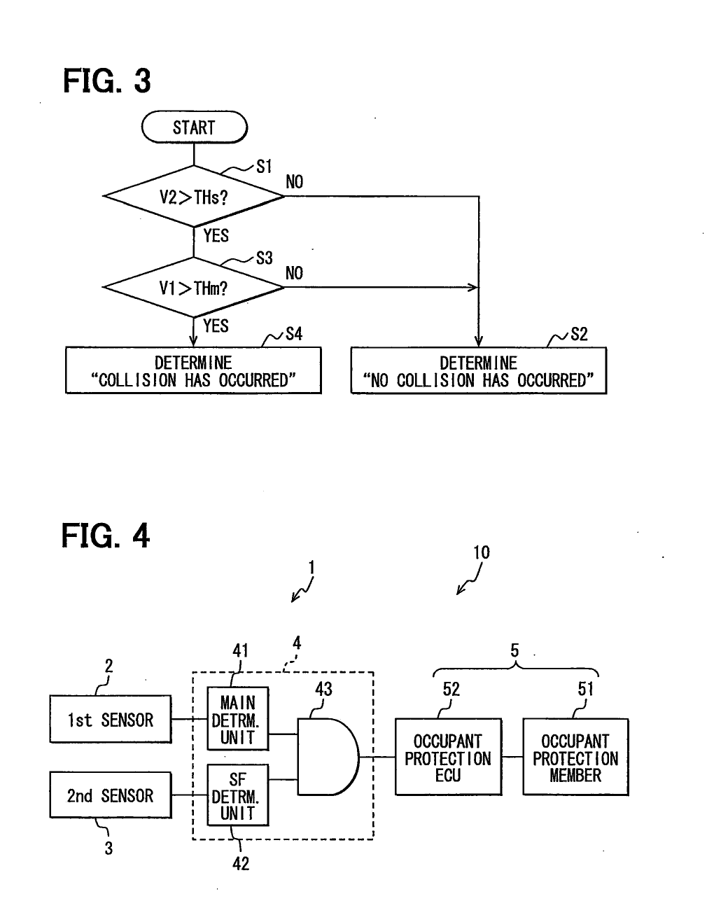

Next, an operation of the determination unit 4 according to the present embodiment will be described with reference to FIG. 3.

When a sensing operation begins, the determination unit 4 compares an output value V2 from the second sensor 3 with the safing threshold THs at S1. When the output value V2 of the second sensor 3 is equal to or lower than the safing threshold THs, corresponding to “No” at S1, the determination unit 4 determines that no side collision has occurred at S2.

When the output value V2 of the second sensor 3 is greater than the safing threshold THs, corresponding to “Yes” at S1, the determination unit 4 compares an output value V1 from the first sensor 2 with the main threshold THm at S3. When the output value V1 of the first sensor 2 is equal to or lower than the main threshold THm, corresponding to “No” at S3, the determination unit 4 determines that no side collision has occurred at S2. When the output value V1 of the first sensor 2 is greater than the main threshold THm, corresponding to “Yes” at S3, the determination unit 4 determines that a collision has occurred at S4. In this way, the determination unit 4 determines that a collision has occurred on condition that the output value V2 of the second sensor 3 is greater than the safing threshold THs as well as the output value V1 of the first sensor 2 is greater than the main threshold THm. In the other conditions, the determination unit 4 determines that no collision has occurred. In other words, the determination unit 4 determines that a collision has occurred only when the output value V2 of the second sensor 3 is greater than the safing threshold THs and the output value V1 of the first sensor 2 is greater than the main threshold THm.

The collision detecting device 1 constitutes an occupant protection system 10 together with an occupant protection device 5, as shown in FIGS. 1 and 2. The occupant protection device 5 includes occupant protection member 51 and an occupant protection ECU 52. The occupant protection member 51 serves to protect an occupant from an impact of a collision. For example, the occupant protection member 51 includes at least one airbag installed adjacent to the side of the passenger compartment.

The occupant protection ECU 52 is provided by an electronic control unit. The occupant protection ECU 52 controls an operation of the occupant protection member 51, such as activation and inactivation (expansion and non-expansion) of the occupant protection member 51.

The occupant protection ECU 52 receives a determination result indicating whether a collision has occurred or not from the determination unit 4. The occupant protection ECU 52 controls the occupant protection member 51 based on the determination result of the determination unit 4. The occupant protection ECU 52 activates the occupant protection member 51 only when the determination unit 4 determines that a collision has occurred (e.g., S4 in FIG. 3). The occupant protection ECU 52 does not activate the occupant protection member 51 where the determination unit determines that no collision has occurred (e.g., S2 in FIG. 3)

In the above described embodiment, the first sensor 2 disposed in the rear region of the passenger compartment is used as the main sensor. Therefore, the motion of the vehicle caused by a side collision to the rear area of the vehicle can be efficiently detected. Further, the second sensors 3 disposed in the front region of the passenger compartment defined from the rear end of the first seat row towards the front of the vehicle are used as the safing sensors. Therefore, redundancy to the occupant protection ECU 52 can be ensured. Accordingly, even if the number of sensors is reduced as compared with a device where multiple sensors are arranged at each side of the vehicle, it is less likely that collision detection accuracy will be degraded.

Since the first sensor 2 is used as the main sensor, it is not necessary to mount multiple sensors as the main sensors at the rear areas of the sides of the vehicle, such as at the sides of the second seat row and the third seat row. As such, the number of sensors reduces, and hence manufacturing costs reduce.

The first sensor 2 can be provided by a sensor that is generally used as a floor safing sensor for a vehicle rear region. In this case, for example, the detection of a side collision to the front area of the vehicle is performed using the second sensors 3 as main sensors and using an acceleration sensor 9 disposed in the front region of the passenger compartment as the safing sensor. That is, the second sensors 3 are commonly used in the detection of a side collision to the front area and in the detection of a side collision to the rear area.

According to the collision detecting device 1 and the occupant protection system 10 of the above described exemplary embodiment, the manufacturing costs reduces as the number of sensors reduces, without degrading the detection accuracy.

### Modifications

The present disclosure is not limited to the above described exemplary embodiment, but may be modified in various other ways. For example, the acceleration sensor 9 disposed in the front region of the passenger compartment may be used as the second sensor 3. In other words, the second sensor 3 may be provided by the sensor that is used as the safing sensor in the detection of the side collision to the front area of the vehicle.

In a case where a yaw rate sensor is mounted in the vehicle, the yaw rate sensor may be used as the second sensor 3. Also in this case, the safing threshold THs is a value smaller than a value of the main threshold THm so that the sensor output value can easily exceed the safing threshold THs. The yaw rate sensor may be a sensor integral with the acceleration sensor 9. The second sensors 3 may provided by sensors installed in the inside of the door panel of the first seat row. Also in these cases, the redundancy can be ensured in the collision detection of the collision detecting device 1 and activation control of the occupant protecting apparatus 10.

As shown in FIG. 4, the determination unit 4 may include a main determination section 41, a safing determination section (SF determination section) 42 and an AND circuit 43. The main determination section 41 compares the output value V1 of the first sensor 2 with the main threshold THm in accordance with the signal output from the first sensor 2. The safing determination section 42 compares the output value V2 of the second sensor 3 with the safing threshold THs in accordance with the signal output from the second sensor 3. The AND circuit 43 provides a logical product gate. The AND circuit 43 receives signals from the main determination section 41 and the safing determination section 42, and transmits a signal to the occupant protection ECU 52. The AND circuit 43 outputs a signal indicating a high level only when both the signals from the main determination section 41 and the safing determination section 42 indicate a high level.

Namely, the determination unit 4 compares the output value V1 of the first sensor 2 with the main threshold THm and the output value V2 of the second sensor 3 with the safing threshold THs, and makes a determination through the AND circuit 43. The determination unit 4 determines that a collision has occurred only when the output values from both the main determination section 41 and the safing determination section 42 are greater than the respective thresholds. The AND circuit 43 is connected to the occupant protection ECU 52. The AND circuit 43 provides a signal indicating that “a collision has occurred” to the occupant protection ECU 52. In this way, the determination can be performed by comparing the output value of each of the sensors with the corresponding threshold during the sensing. Also in this case, the advantageous effects similar to those of the above described exemplary embodiments are achieved. In the operation shown in FIG. 2, the order of the step S1 and the step S3 may be reversed.

Examples of the occupant protection member 51 are side airbags, curtain shield airbags, door mount curtain airbags and the like. In FIG. 1, although the occupant protection member 51 is illustrated only at sides of the second seat row and the third seat row, the occupant protection member 51 is also installed at both sides of the first seat row. The determination unit 4 and the occupant protection ECU 52 may be integrated into one ECU. Even in a vehicle without having the third seat row, sensors at the sides of the second seat row are not necessary. Therefore, the similar advantageous effects are achieved.

Accordingly, in an embodiment, a collision detecting device includes a first sensor 2, a second sensor 3, 9, and a determination unit 4. The first sensor 2 is disposed in the rear region of the passenger compartment that is defined from the first seat row toward the rear of the vehicle, and detects a motion of the vehicle with regard to a collision. The second sensor 3, 9 is disposed in one of the front region of the passenger compartment that is defined from the rear end of the first seat row toward the front of the vehicle and the side area of the first seat row. The second sensor 3, 9 detects a motion of the vehicle with regard to a collision. The determination unit 4 determines that a side collision has occurred only when an output value V2 of the second sensor 3, 9 is greater than the safing threshold THs and an output value V1 of the first sensor 2 is greater than the main threshold THm. Also in this case, the similar advantageous effects are achieved.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A collision detecting device for detecting a collision to a side of a vehicle, comprising:
a first sensor disposed in a rear region of a passenger compartment defined from a first seat row towards a rear of the vehicle and detecting a motion of the vehicle with regard to a collision;
a second sensor disposed in one of a front region of the passenger compartment defined from the first seat row towards a front of the vehicle and a side area of the first seat row, and detecting a motion of the vehicle with regard to a collision; and
a determination unit determining a collision to a side of the vehicle based on output signals from the first sensor and the second sensor, wherein
the determination unit stores a safing threshold and a main threshold that is a value greater than a value of the safing threshold, and determines that a collision has occurred only when an output value of the second sensor is greater than the safing threshold and an output value of the first sensor is greater than the main threshold.

2. The collision detecting device according to claim 1, wherein
the second sensor is an acceleration sensor and is disposed in the side area of the first seat row.

3. An occupant protection system comprising:
the collision detecting device according to claim 1; and
an occupant protection device activated based on a determination result of the collision detecting device to protect an occupant from an impact of a collision.
